(19) United States
(12) Patent Application Publication
(10) Pub. No.: US 2015/0266205 A1
(43) Pub. Date: Sep. 24, 2015

(54) METHOD FOR BENDING CERAMIC TILES

(71) Applicant: BREVETTI 2000 S.R.L., Imola (Bologna) (IT)

(72) Inventor: Pier Paolo Conti, Faenza (IT)

(73) Assignee: BREVETTI 2000 S.r.l., Imola (BO) (IT)

(21) Appl. No.: 14/435,194

(22) PCT Filed: Oct. 24, 2012
(86) PCT No.: PCT/IT2012/000325

§ 371 Date: Apr. 13, 2015

(51) Int. Cl. B28B 11/00

(52) U.S. Cl. CPC B28B 11/005

(57) ABSTRACT

The invention relates to an improved method for bending ceramic tiles. The method comprises the stages of making grooves in the lower surface of the tile in the area of the tile to be bent, filling the grooves obtained on the tile with a filling material compatible with the material of which the tile is made, covering the grooves with a flexible strip of incombustible refractory-material, anchoring the strip to the surface of the tile, heating the area of the tile to be bent up to the softening temperature of the area itself and cooling the modelled tile thus obtained.

The subject matter of the present invention is an improved method for bending ceramic tiles. In particular, the task set by the present invention is to obtain special non-planar ceramic parts starting from flat tiles.

For bending ceramic tiles a method has been known for some time, described in patent EP 1487621, which envisages the heating of the whole tile or even of the area of the tile to be bent, until the softening temperature of the actual area is reached, and the subsequent deformation of the softened area until the pre-established shape is obtained; this method further envisages that, before the tile heating stage, grooves are made in the lower surface of the tile at the position where the deformations are to be obtained.

Special steps are also known, described in patent IT 1354442, which envisage filling, generally and preferably before heating the tile, the grooves made on the tile with a filling material, for example, a vitreous paste compatible with the material of which the tile is made; the tile is subsequently rested on a support, shaped with the shape to be obtained from the finished part, so that, when it softens, the tile rests on the shaped support taking on the shape, thanks also to the grooves that help it to soften. The heating causes the tile to soften and the filling material to melt, which is intimately integrated with the material of which the tile is made; in this way, the part of the tile that has been deformed is strengthened.

With these methods and steps, starting from flat tile, special parts widely illustrated and described in the above-mentioned patents can be obtained with an increase of two or three times of the tensile and compressive strength.

The prior art illustrated above has the disadvantage that, when it is melted and before its consolidation and its integration with the material of the tile, the filling material could drip and run out, even only partially, of the grooves obtained on the tile; furthermore, the melted filling material tends to get stuck to the support and to become detached from the grooves in the tile; following this, a big problem arises during firing since the material used for filling gets stuck to the support with disastrous consequences in terms of the production performance.

An object of the present invention is to provide a method that allows the disadvantages of the prior art to be eliminated whilst maintaining the advantages.

An advantage of the present invention is that of providing a method that is easy and cheap to perform.

Further characteristics and advantages of the present invention will become more apparent from the following detailed description of the stages of the method in question.

The method in question is used to improve the known methods, whilst maintaining the functionalities of such methods that allow, at contained costs, the mass production of special monolithic non-planar parts (L-shaped, U-shaped, curved, etc.) having practically the identical composition, finish and colour tone as all the normally produced ceramic tiles, and that allow perfect resemblance between the starting tiles and the special parts thus obtained.

The method in question applies to tiles to be modelled in which grooves have been made in the lower surface of the tile in a position that corresponds to the area of the tile to be bent, and in which the grooves have been filled with a filling material compatible with the material of which the tile is made; the various procedures for obtaining the grooves, their shapes and positioning and the materials used for the filling are known and well described in the patents mentioned above, and are not therefore repeated.

According to the method in question, after the filling stage the grooves are covered with a flexible strip made with an incombustible refractory material up to at least the softening temperature of the tile; this flexible strip is preferably a wool-based insulating paper strip, of the known type, resistant up to a temperature of approximately 1300° C. A known strip that is suitable for this operation is for example the one produced by the company Thermal Ceramics known as “Superwool 607 HT Paper”.

The strip is then anchored to the surface of the tile on which the grooves are obtained. For that purpose, adhesion of the strip to the filling material which is normally a sticky paste may be sufficient; should this not be considered sufficient it is possible to anchor the flexible strip to the tile, for example using discrete dots of glue.

Once the strip has been applied, the tile is rested on a shaped support and is heated, at least in the area of the tile in which the grooves are obtained filled with the filling material and that is to be bent, up to the softening temperature of the area itself. In this stage, the filling material is also softened and integrates intimately with the material of which the tile is made; however, the strip does not undergo any changes due to the heating but, given its nature, it simply flexes so as to follow, at least partially, the deformation of the area of the tile subject to bending.

The tile thus modelled is then cooled and if necessary subjected to cycles of refiring, as happens in the known methods. The flexible strip remains anchored to the tile for the whole bending procedure and is preferably removed from the tile at the end of the procedure.

With the method described above it is possible to obtain, as in the known methods and starting from flat ceramic tiles, particularly strong special parts of various shapes; with respect to the known methods, the method in question allows the problems caused by the presence of the filling material to be prevented, which in the known methods, before or during its melting, can run out of the grooves made in the tiles (by dripping or sticking to the support) and hence compromise the strength of the special part obtained.

1. Improved method for bending ceramic tiles, of the type involving the stages of making grooves in the lower surface of the tile in a position that corresponds to the area of the tile to be bent, filling the grooves obtained on the tile with a filling material compatible with the material of which the tile is made, resting the tile on a shaped support, heating at least the area of the tile to be bent up to the softening temperature of the area itself, cooling the modelled tile thus obtained; characterised in that, after the filling stage, the grooves are covered with a flexible strip, made with an incombustible refractory material up to at least the softening temperature of the tile, which is anchored to the surface of the tile on which the grooves are obtained.

2. Method according to claim 1, characterised in that said flexible strip remains anchored to the tile for the whole bending procedure and is removed from the tile at the end of the procedure.

3. Method according to claim 1, characterised in that said flexible strip is anchored to the tile through discrete dots of glue.

4. Method according to claim 1, characterised in that said flexible strip is a wool-based insulating paper strip, of the known type, resistant up to a temperature of approximately 1300° C.
